(19) United States
(12) Patent Application Publication
(10) Pub. No.: US 2007/0138301 A1
(43) Pub. Date: Jun. 21, 2007

(54) SMART CARD MODULE

(75) Inventor: Kalman Cinkler, Munich (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Munich (DE)

(21) Appl. No.: 11/549,778

(22) Filed: Oct. 16, 2006

(30) Foreign Application Priority Data
Oct. 14, 2005 (DE) 10 2005 049 256.8

(51) Int. Cl. G06K 19/06; G06K 7/06

(52) U.S. Cl. 235/492; 235/441

(57) ABSTRACT

A smart card module including first and second card contacts positioned within a boundary line. Each first card contact has one of a plurality of regions, wherein the size of each region conforms to the ISO 7816 card contact standard and conforms with regard to its distance from and its arrangement with respect to one of the other regions to the ISO standard 7816. One of the second card contacts is arranged between at least one of the first card contacts and the boundary line or includes a part of one of the regions. The card contacts include a contact surface and at least one chip arranged on a side opposite the contact surface. The chip includes chip contacts, at least one of which is electrically connected to the card contacts.

### CROSS-REFERENCE TO RELATED APPLICATION

This application claims priority to German Patent Application Serial No. 102005049256.8, which was filed on Oct. 14, 2006, and is incorporated herein by reference in its entirety.

### FIELD OF THE INVENTION

The invention relates to a smart card module, a smart card, a smart card contact-making device, and a method for operating a smart card.

### BACKGROUND OF THE INVENTION

Smart cards are widespread and are used by a multiplicity of applications. Smart cards are used for example as telephone cards, cash cards, smart cards with a key function or smart cards with a data storage function. Multifunction smart cards that can be used for a plurality of applications are becoming increasingly widespread. Communication with such smart cards can be effected contactlessly and/or via card contacts on the smart card.

Smart cards which exhibit contacts for the most part have eight contacts arranged in accordance with the ISO standard 7816-2. The size of card contacts, their arrangement on the smart card and their function are standardized in the standard. Eight rectangular contact regions arranged in two columns each having four contact regions one below another are provided for contact-making purposes. Such smart cards are also referred to as ISO cards.

ISO-conforming card contacts are configured in such a way that their card contacts each comprise one of the contact regions. The eight card contacts are usually arranged in such a way that in each case four contact regions are arranged in two columns and a contact region connected to one of the card contacts is provided between the columns. This is usually the card contact provided for the application of the reference potential.

The ISO standard also provides smart cards having only six card contacts arranged in such a way that they each comprise one of six contact regions arranged in two columns each having three contact regions one below another.

For access to the smart card, contact-making elements of a contact-making device make contact with the card contacts of the smart card. For making contact with ISO cards, the contact-making elements are embodied and positioned in such a way that they make contact with the card contacts in regions predefined by the ISO standard. A customary embodiment of a contact-making element comprises a metallic, resilient web with a contact region. The web may be mounted laterally with respect to the card contact array. The contact region presses onto the card contact owing to the spring force. Other embodiments of the contact-making elements are also conceivable.

In view of many new areas of application and the multifunctionality sought for the smart cards, a larger number of card contacts is necessary in order to be able to operate the smart card for these applications and/or in combination with other applications. It has been found that the eight ISO card contacts are usually insufficient for this. On account of the widespread use of the ISO cards, a backward compatibility of the smart cards having additional card contacts with the ISO cards is indispensable in order that they can be accessed even by means of conventional contact-making devices or ISO cards can be accessed by means of contact-making devices for smart cards having additional card contacts.

In the case of smart cards having further card contacts in a central region between the ISO-conforming card contacts, problems can arise if an ISO card is inserted into a contact-making device for the smart card described previously. The contact-making elements provided for the additional card contacts are grounded by the centrally arranged grounding area of the ISO card. This is accompanied by disadvantages during the operation of the contact-making device.

Problems can also occur in the case of the contact-making elements of the contact-making device. The springs brought up laterally for making contact with the additional card contacts have a longer lever than the springs assigned to the ISO card contacts, with the result that it is difficult to apply the pressure necessary for making contact to the spring. Consequently, the contact resistance between the additional card contacts and the contact-making elements may be greater than that between the ISO card contacts and the contact-making elements.

### SUMMARY OF THE INVENTION

One aspect of the invention relates to a smart card module, having first card contacts positioned within a boundary line, each first card contact including one of a plurality of contact regions, each contact region conforming in size to a card contact size standardized in ISO standard 7816 and conforming with regard to distance from and arrangement with respect to one of the other contact regions to the card contact arrangements standardized in the ISO standard 7816, and second card contacts positioned within the boundary line, one of the second card contact being arranged between at least one of the first card contacts and the boundary line or including a part of one of the regions. The first and second card contacts include a contact surface. At least one chip including an integrated circuit is arranged on an opposite side to the contact surface. The chip includes chip contacts which are electrically connected to the integrated circuit and at least one of which is electrically connected to the card contacts.

### BRIEF DESCRIPTION OF THE DRAWINGS

FIG. 1 shows a smart card with the regions with which contact is to be made in accordance with the ISO standard 7816.

FIG. 2 shows a smart card with a card contact array.

FIG. 3 shows the card contact array of one exemplary embodiment.

FIG. 3A shows the contact regions of the card contact array in accordance with FIG. 3.

FIG. 3B shows a rear side of a chip module with the card contact array in accordance with FIG. 3.

FIGS. 4 and 5 show the card contact arrays of different exemplary embodiments.

FIGS. 4A and 5A show contact regions of the card contact arrays in accordance with FIGS. 4 and 5, respectively.

FIG. 6 shows a contact-making device.

FIGS. 7 and 8 show the card contact arrays of different exemplary embodiments.

FIGS. 7A, 7B and 8A show the contact regions of the card contact arrays in accordance with FIGS. 7 and 8.

FIGS. 9 and 10 show arrangements of the contact-making elements of the contact-making device.

FIGS. 11 and 12 show the card contact arrays of different exemplary embodiments.

FIGS. 11A and 12A show the contact regions of the card contact arrays in accordance with FIGS. 11 and 12.

FIGS. 13 to 15 show the card contact arrays of different exemplary embodiments.

FIG. 15A show the contact regions of the card contact array in accordance with FIG. 15.

FIGS. 16 to 18 show the card contact arrays of different exemplary embodiments.

FIGS. 19 to 24 show steps of the handshake protocol between the smart card and the contact-making device.

FIG. 25 shows the connection of an ISO card to the contact-making device.

FIG. 26 shows the connection of the smart card to a conventional contact-making device.

### DETAILED DESCRIPTION OF THE INVENTION

One advantage of an exemplary embodiment of the smart card according to the invention is that contact can be made more easily with the second card contacts of the smart card module mounted in a smart card, since laterally mounted spring arms for making contact therewith are shorter than laterally mounted spring arms for making contact with the first card contacts.

In order to operate an exemplary embodiment of a smart card in accordance with the ISO standard, it suffices for the first card contacts to conform with regard to their size and arrangement to the card contacts designated as C1, C2, C3, C5 and C7 in the ISO standard 7816. Consequently, in each case a plurality of second card contacts may be provided in regions which, according to ISO standard 7816, are provided for the card contacts C6, and in particular the user-specifiable card contacts C4, C8.

The second card contacts are advantageously arranged in a manner offset with respect to the first card contacts. The advantage of such an exemplary embodiment is that the spring contacts for making contact with the second card contacts are positioned between the spring contacts also required heretofore for making contact with the first card contacts, which facilitates the construction of a corresponding contact-making device.

What is disadvantageous about this exemplary embodiment is that the spring contacts which are mounted laterally with respect to the card contact array, and the contact regions of which have a finite extent, touch the card contact array between two first card contacts in the event of poor adjustment, that is to say if the spring contacts are too long. The corresponding first card contacts are short-circuited. This is avoided by means of a card contact array having second card contacts whose upper or lower edges are in each case oriented at a line with upper and lower edges, respectively, of a first card contact.

A second card contact may be provided in the region between two lines at which the upper and lower edge, respectively, of the first card contact is oriented. This simple design simultaneously improves the mechanical flexibility of the card contact array.

Such second card contacts may be divided along vertical or horizontal separating lines into two or four or more second card contacts, which is associated with only little design and manufacturing outlay.

The division of the regions which are in each case occupied by a card contact of a card contact array of an ISO card into first and second card contacts does not have to be effected in the same way for each region. In one advantageous exemplary embodiment of a card contact array, only some of the regions are divided into first and, if appropriate, a plurality of second card contacts. The arrangement and number of the card contacts can thus be adapted to the requirements of the applications.

The separating lines between the adjacent first and second card contacts may run in perpendicular or zigzag fashion. In this way, the contact regions assigned to the card contacts can be adapted to the adjustability and accuracy of the contact-making elements that make contact.

The smart card module having the first and second card contacts is advantageously mounted in a smart card having an ISO standard-conforming card size in such a way that the first card contacts are positioned on the smart card in such a way that their distance from the card edge conforms to the ISO standard in order to ensure backward compatibility with the smart card.

It is also conceivable for the positioning of at least some of the first and second card contacts to conform to a different standard than the ISO standard 7816, in order to be able to use such a smart card module for a multiplicity of smart cards.

One exemplary embodiment of a smart card is embodied for detecting whether it is connected to a conventional contact-making device, that is to say one which makes contact only with the ISO contacts, or to a contact-making device that has been adapted with regard to the card contact arrangement of the smart card. The card can consequently be operated backward compatibly with the ISO standard. For detection purposes, means are provided which detect whether a potential is applied to a second card contact if the potential is applied to the assigned first card contact. The mutually assigned card contacts are arranged in a region that is usually occupied by a single card contact in an ISO card.

In order to operate such an exemplary embodiment of a smart card in a conventional contact-making device, too, it is advantageous if the second card contacts can be deactivated.

In order to communicate with the contact-making device in the context of a handshake protocol, second card contacts can be coupled to first card contacts internally within the smart card in order to provide a potential applied thereto for signaling at the second card contacts.

One exemplary embodiment of a contact-making device for operating a smart card described above comprises first and second contact-making elements embodied for making contact with the first and second card contacts, respectively, or at least some of the card contacts, of the smart card.

One exemplary embodiment of a contact-making device is embodied for distinguishing whether an ISO card or a smart card having first and second card contacts is connected. Access to the smart card is affected depending on the result. Consequently, the contact-making device is also backward compatible.

One aspect of the invention relates to a method for operating a smart card comprising the following steps: application of a first potential to a first region of a card contact array or application of the first potential to the first region of the card contact array and to a second region of the card contact array which is assigned to the first region, and the smart-card-internal testing of whether the first potential is present at the second region of the card contact array.

An advantage of an exemplary embodiment of the method is that the backward compatible smart card firstly distinguishes whether it is connected to a conventional contact-making device embodied only for making contact with the card contacts of an ISO card, or is connected to a contact-making device which makes contact with the first and second card contacts. In the first-mentioned case, the second card contacts, that is to say including the card contact which comprises the second region, are advantageously deactivated in order to ensure backward compatibility and to be able to operate the smart card at a conventional contact-making device, too.

In one exemplary embodiment, a second potential is advantageously applied to a third region of the contact area array in order to supply the smart card with voltage.

As soon as an exemplary embodiment of a smart card has detected that the first potential is present at the second card contact which comprises the second region, a fourth region, or the card contact comprising the region, is coupled to the second potential internally within the smart card. This signals to the contact-making device that the smart card is functionally ready.

It should be noted that a card contact in each case comprises the first and second regions and also the third and fourth regions in an exemplary embodiment of an ISO card. By contrast, a respective card contact comprises the regions in the backward compatible smart card, wherein the card contact comprising the second region is assigned to the card contact comprising the first region. The card contact comprising the third region is assigned to the card contact comprising the fourth region.

For confirmation, the contact-making device decouples the second potential from the second region. A time counter simultaneously starts in the contact-making device. The fact of whether the smart card decouples the second potential from the fourth region is detected during the time interval predefined by the time counter. The contact-making device deduces from this that a smart card having first and second card contacts is connected.

If the time interval elapses without the potential having been decoupled from the second region, it must be assumed that the first and second regions are permanently short-circuited, that is to say that a single card contact of an ISO card comprises them. This results in the conclusion that an ISO card is connected.

After this handshake protocol, the communication between the contact-making device and the smart card is effected in a normal operating mode.

The invention is explained below on the basis of exemplary embodiments with reference to the drawing.

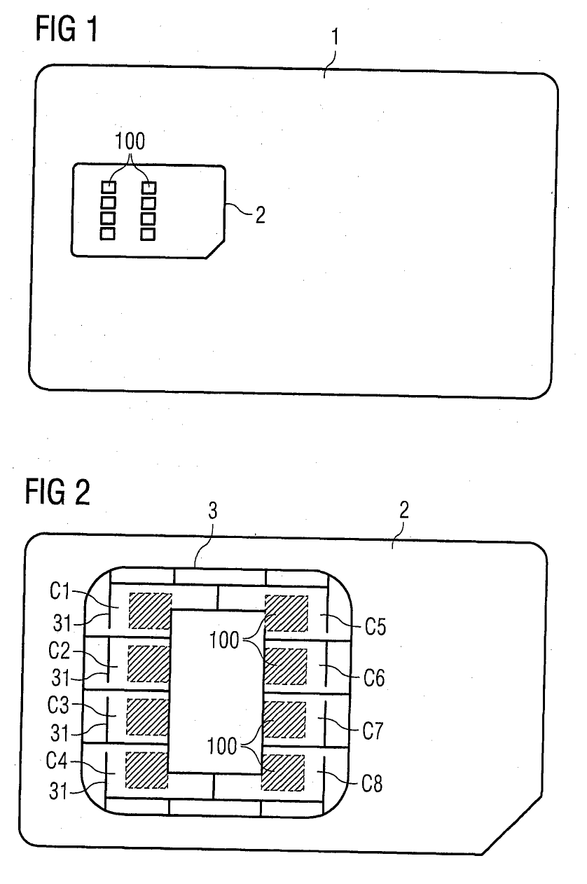

FIG. 1 shows a smart card 1 in the ID-1 format used for telephone cards, for example, with the regions 100 provided for contact-making in accordance with the ISO standard 7816-2.

The contact regions 100 are arranged in two columns each having four contact regions 100 one below another. The contour line 2 illustrated within the smart card 1 indicates the ID-000 format of a smart card such as is often used in mobile telephones. In such a smart card, too, the extent of the contact regions 100 and their arrangement relative to one another in accordance with the ISO standard 7816-2 remain unchanged. On account of the smaller card size, however, a card contact array having the card contacts occupies a larger region of the smart card relative to its card size.

FIG. 2 shows the smart card 2 exhibiting contacts in the ID-000 format with the card contact array 3 in detail. A smart card module, also known as chip module, which is mounted in recessed fashion in the top side of the card body, comprises the card contact array 3. The card contact array 3 comprises eight card contacts. They are designated in accordance with the ISO standard 7816-2 by the letter “C” followed by a number between “1” and “8”: C1, C2, C3, C4, C5, C6, C7, C8. The card contacts are numbered consecutively beginning in the left-hand column from top to bottom, then in the right-hand column from top to bottom. The card contacts C1, C2, C3, C4, C5, C6, C7, C8 are shaped and arranged in such a way that a respective one of the card contacts C1, C2, C3, C4, C5, C6, C7, C8 comprises one of the contact regions 100.

The card contacts C1, C2, C3, C4 and C5, C6, C7, C8 are respectively arranged in two columns. The region between the columns is largely occupied by a contact area connected to the card contact C5.

It should be noted that the form of the card contact array 3 is not fixedly predefined by the ISO standard. Rectangular, round or other forms are also conceivable if the card contacts C1, C2, C3, C4, C5, C6, C7, C8 comprise the contact regions 100.

The card contact array 3 comprises a patterned conductive layer, for example copper with a gold coating. The patterning separates the individual card contacts from one another. Narrow cutouts 31 of the patterning which extend from the edge of the card contacts C1, C2, C3, C4, C5, C6, C7, C8 into the inner regions thereof increase the mechanical flexibility of the card contact array 3.

According to the ISO standard, only five of the eight card contacts C1, C2, C3, C4, C5, C6, C7, C8 are predefined with regard to their signal allocation: C1 serves for the application of a supply potential, C2 serves for the application of a reset signal, C3 serves for the application of a clock signal, C5 serves for the application of a reference potential, which is also referred to as ground, and C7 serves for the transmission of a first data signal. C6 is provided for a second data signal, if present. The remaining ISO card contacts C4 and C8 are available for user-specific allocation. Not providing them is conceivable, too.

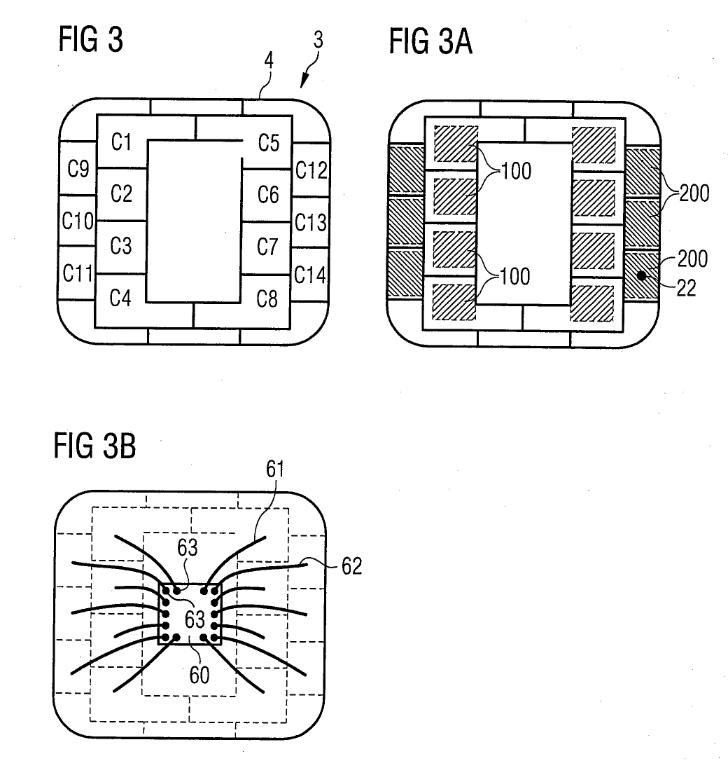

FIGS. 3, 4 and 5 show various exemplary embodiments of the card contact array 3 of the smart card.

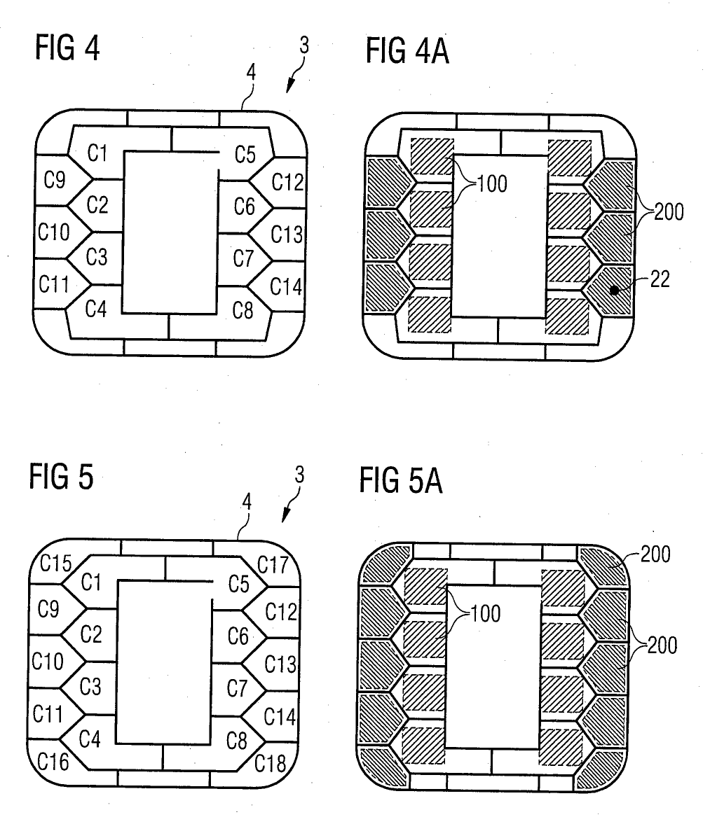

Second card contacts are provided in order that a card contact array 3 having first card contacts in accordance with the ISO standard, with an unchanged or virtually unchanged size like a conventional card contact array comprising only ISO card contacts, is expanded by additional card contacts. Six second card contacts C9, C10, C11, C12, C13, C14 are provided in the exemplary embodiments illustrated in FIGS. 3 and 4. The second card contacts are arranged in the edge regions between the first card contacts C1, C2, C3, C4, C5, C6, C7, C8, which comprise the contact regions in accordance with the ISO standard, and a boundary 4 of the card contact array 3. Moreover, yet another four second card contacts C15, C16, C17, C18 are provided in the exemplary embodiment illustrated in FIG. 5. The card contacts are arranged in the corner regions of the card contact array 3.

The second card contacts C9, C10, C1, C12, C13, C14 are arranged in a manner offset with respect to the first card contacts C1, C2, C3, C4, C5, C6, C7, C8.

FIG. 3 shows a first exemplary embodiment, in which the first card contacts C1, C2, C3, C4 and C5, C6, C7, C8 and the adjacent second card contacts C9, C10, C1 and C12, C13, C14, respectively, are oriented along a respective perpendicular. This results in rectangular second card contacts C9, C10, C1, C12, C13, C14.

FIG. 3B shows the rear side of the smart card module with card contacts in accordance with FIG. 3. A chip 60 having an integrated circuit is arranged on the rear side. Chip contacts 63 are connected to the integrated circuit in the chip 60 and are connected via wire bonding wires 61, 62 to the first and second card contacts. It is also conceivable for the chip contacts 63 only to be connected to some of the first and second card contacts.

Usually, but not necessarily, the card contacts are applied on a substrate on whose rear side the chip 60 is mounted. Through cutouts in the substrate or plated-through holes it is possible to connect the card contacts to the chip contacts 63. Other contact-making techniques, for example flip-chip contact-making arrangements, are also conceivable.

FIG. 3A shows the contact regions 100, 200 for making contact with the card contacts by means of a contact-making device to which the smart card can be connected. Alongside the first contact regions 100, within which contact is made with the ISO-conforming card contacts C1, C2, C3, C4, C5, C6, C7, C8, second contact regions 200, within which contact is made with the second card contacts C9, C10, C11, C12, C13, C14, are arranged in an offset manner.

The card contact regions 100 predefine for the contact-making device provided for making contact with the smart card those regions on the card contact array 3 within which contact is to be made with the corresponding card contact. The contact regions identify the tolerance range for the adjustment of the contact-making element for making contact with the card contact.

In order to ensure the compatibility of the first card contacts C1, C2, C3, C4, C5, C6, C7, C8 with respect to the ISO standard, the contact regions 100 must be able to be positioned within the edges of the first card contacts in such a way that they in each case conform with regard to their size to the card contact size standardized in the ISO standard 7816 and conform with regard to their distances from and their arrangement with respect to the other contact regions 100 to the card contact arrangements standardized in the ISO standard 7816. Conformity is also ensured if the contact regions within which contact can respectively be made with a card contact are larger than the minimum card contact dimensions specified in the ISO standard. However, the actual contact-making by means of a contact-making device will usually be effected in ISO conforming fashion within the regions predefined in the ISO standard.

In FIG. 3A, a point 22 in one of the contact regions 200 indicates by way of example the optimum location for making contact with the corresponding second card contact C14. The optimum contact-making location 22 is usually approximately central on the card contact C14, so that small deviations in any direction during the adjustment of the contact-making element have no effects on the quality of the contact made with the card contact. The situation where fault-free contact is made is ensured as long as contact is made in the hatched contact region 100, 200 identified.

Disadvantages of the arrangement of the second card contacts C9, C10, C11, C12, C13, C14 offset with respect to the first card contacts C1, C2, C3, C4, C5, C6, C7, C8 become clear if the contact-making element for making contact with the second card contact, for example C14, is positioned so close to the first card contacts, C7 and C8 in this example, that it touches the card contact array 3 on the separating line between the card contacts C7 and C8. On account of the finite extent of the contact-making element, which is also illustrated by the size of the point 22, the card contacts C7 and C8 are thereby short-circuited.

FIG. 4 and FIG. 5 show further exemplary embodiments of the card contact array 3 with first card contacts and second card contacts arranged offset with respect thereto. The separating line running between the first and second card contacts is zigzagged in these exemplary embodiments. The second card contacts C9, C10, C11, C12, C13, C14 are pentagonal. The pentagonal form enlarges the region between the optimum contact-making location 22 of the second card contacts C9, C10, C11, C12, C13, C14, as illustrated in FIG. 4A, and the edges adjacent to the first card contacts C1, C2, C3, C4, C5, C6, C7, C8. Consequently, when making contact with a second card contact, for example C14, the possibility of a short circuit of the adjacent first card contacts, C7 and C8 in the example, in the case of an inaccurately adjusted contact-making element is reduced.

FIG. 5 shows a third exemplary embodiment of the card contact array 3, in which the first card contacts C1, C4, C5, C8 are shaped in such a way that further second card contacts C15, C16, C17, C18 can be arranged in corner regions of the card contact array. FIG. 5A shows the corresponding contact regions 100, 200 of the card contact array in accordance with FIG. 5.

The advantage of the first and second card contacts arranged in an offset manner resides in the simple construction of a contact-making device embodied for making contact with corresponding smart cards having such card contact arrays.

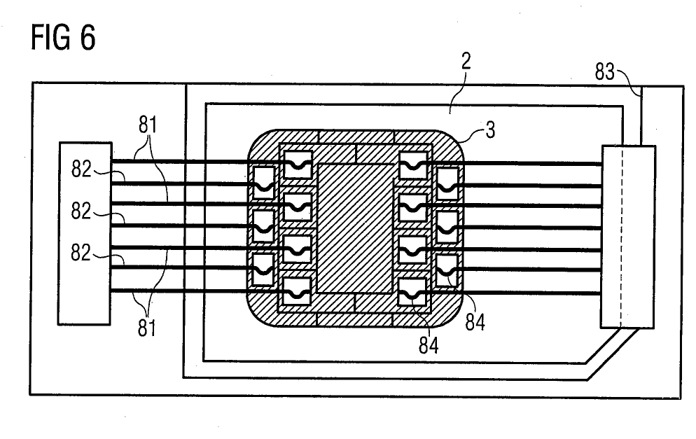

FIG. 6 shows a block diagram of the contact-making device. The smart card 2 is brought into a predefined position for contact-making purposes. This may be effected for example by introducing the smart card 2 into a slide-in unit 83, a form of which predefines the position of the smart card 2. The card contacts of the smart card 2 are arranged in accordance with FIG. 3.

The contact-making device comprises contact-making elements 81, 82 embodied as resilient metal arms, by way of example, which are mounted laterally with respect to the card contact array 3. Contact-making elements fixed above the card contact array 3 are also conceivable. The contact-making elements comprise a contact region 84 which touches the card contact upon connection of the smart card 2. The contact region 84 may be embodied as an end region of the metal arm which is bent in such a way that it touches the smart card. As a result of the spring pressure, contact is made with the first and second card contacts by means of a respective contact region 84. The contact-making elements 82 for making contact with the second card contacts are arranged centrally between the contact-making elements 81 for making contact with the first card contacts.

Exemplary embodiments whose second card contacts are not arranged offset with respect to the first card contacts are described below.

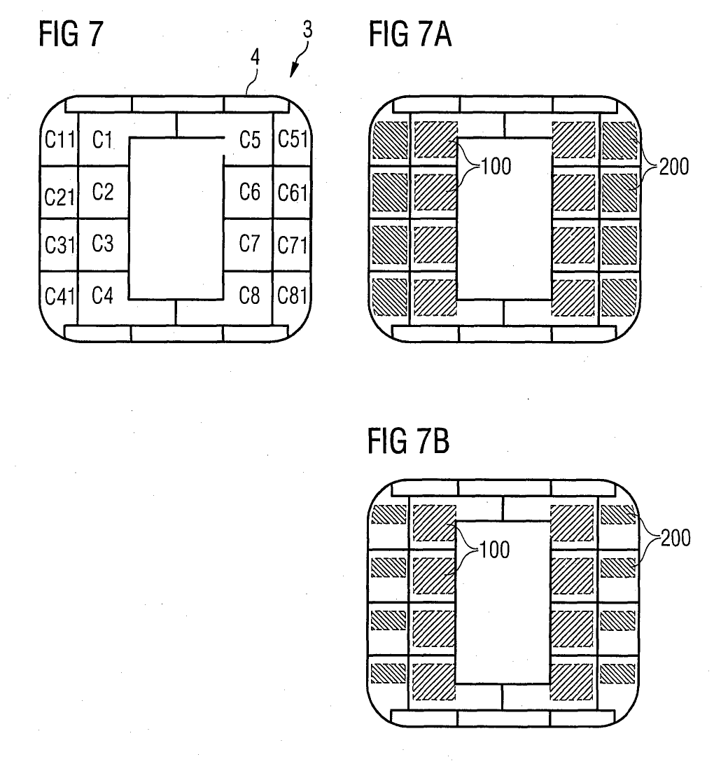

FIG. 7 shows the card contact array 3 of a fourth exemplary embodiment. The card contact array 3 differs from the card contact array 3 of an ISO card by virtue of the fact that 16 card contacts are now provided instead of only eight card contacts. In each case a first and a second card contact C1, C11; C2, C21; C3, C31; C4, C41; C5, C51; C6, C61; C7, C71; C8, C81, separated by a vertical cutout, comprise the region of an ISO card contact of the ISO card. The second card contacts C11, C21, C31, C41, C51, C61, C71, C81 are oriented in such a way that their upper edge and lower edge are aligned with the upper and lower edge, respectively, of the adjacent first card contacts C1, C2, C3, C4, C5, C6, C7, C8 along a respective line.

FIG. 7A shows the first contact regions 100 assigned to the first card contacts C1, C2, C3, C4, C5, C6, C7, C8 and also the second contact regions 200 assigned to the second card contacts C1, C21, C31, C41, C51, C61, C71, C81.

Through divisions of the second card contacts C11, C21, C31, C41, C51, C61, C71, C81, the fourth exemplary embodiment can be developed in order to increase the number of contact areas further.

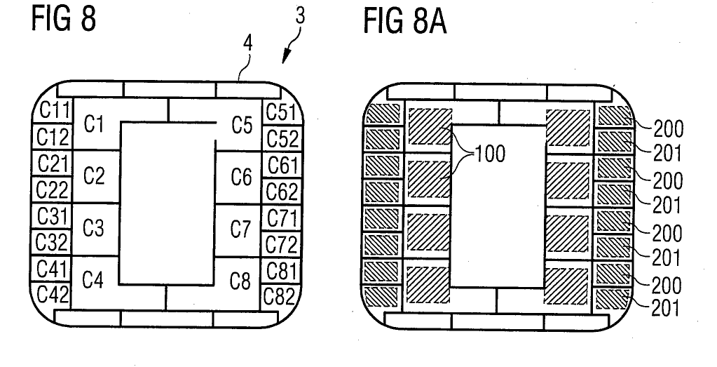

FIG. 8 shows a fifth exemplary embodiment, which differs from the fourth exemplary embodiment in FIG. 7 by virtue of the fact that the second card contacts C11, C21, C31, C41, C51, C61, C71, C81 shown in FIG. 7 are each divided horizontally. A total of sixteen second card contacts C11, C12, C21, C22, C31, C32, C41, C42, C51, C52, C61, C62, C71, C72, C81, C82 is thus obtained.

Through suitable dimensioning of the contact regions of the fourth exemplary embodiment it is possible to ensure compatibility with the fifth exemplary embodiment in order, for example, to be able to operate the fourth and fifth exemplary embodiments in the same contact-making device.

FIG. 7B shows the arrangement of the contact regions of the fourth exemplary embodiment in FIG. 7 in such a way that the contact regions are also compatible with the contact regions of the fifth exemplary embodiment in FIG. 8.

The ISO-conforming contact regions 100 comprise most of the first card contacts C1, C2, C3, C4, C5, C6, C7, C8 respectively assigned to them. The contact regions 200 respectively assigned to the eight second card contacts C11, C21, C31, C41, C51, C61, C71, C81 comprise only a fraction, namely approximately half, of the corresponding card contact. They are positioned in such a way that in the event of a division of the second card contacts C11, C21, C31, C41, C51, C61, C71, C81 illustrated in FIG. 7, enough space still remains for the positioning of contact regions which can be assigned to the further second card contacts resulting from the division.

FIG. 8A shows the arrangement of the contact regions 100, 200, 201 for the first card contacts and for the second card contacts of the card contact array in FIG. 8. The second contact regions 200, 201 have approximately only half the extent of the first contact regions 100. The arrangement of a portion of the second contact regions having the reference symbol 200 matches the arrangement of the second contact regions 200 in FIG. 7B.

When a smart card in accordance with FIG. 8 is connected to a contact-making device for making contact with the arrangement of the contact regions 100, 200 that is illustrated in FIG. 7B, contact is made with at least the first card contacts C1, C2, C3, C4, C5, C6, C7, C8 and also some of the second card contacts, C11, C21, C31, C41, C51, C61, C71, C81.

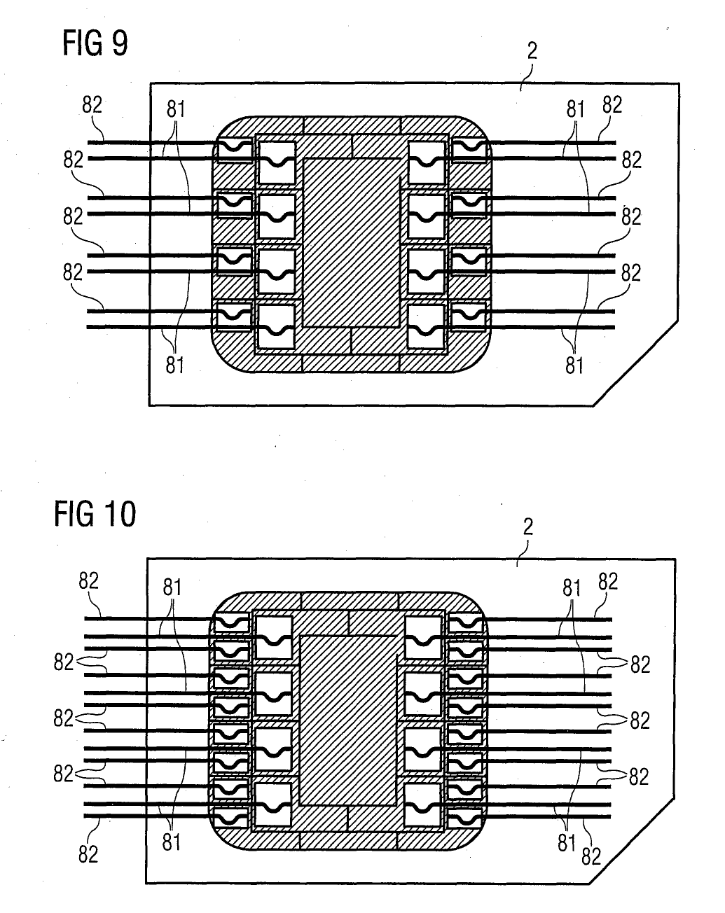

FIG. 9 shows the arrangement of the contact-making elements 81, 82 in a contact-making device embodied for making contact with in each case eight first and second card contacts. This arrangement is suitable for making contact with the card contact arrangement illustrated in FIG. 7. Contact can therefore also be made with half of the second card contacts, C11, C21, C31, C41, C51, C61, C71, C81, of the card contact array 3 in FIG. 8.

The arrangement differs from the arrangement illustrated in FIG. 6 in that the first and second contact-making elements are not arranged equidistantly. The second contact-making elements 82 are arranged at a smaller distance from one of the adjacent first contact-making elements 81 in order to make contact with the second contact region 200 adjacent to the first contact region 100. This arrangement avoids the inadvertent short-circuiting of two first card contacts which can occur in the case of the contact-making device shown in FIG. 6 for smart cards having second card contacts arranged offset with respect to the first card contacts.

FIG. 10 shows the arrangement of the contact-making elements 81, 82 in a contact-making device embodied for making contact with eight first and sixteen second card contacts. This arrangement is suitable for making contact with the card contact arrangement illustrated in FIG. 8. It differs from the arrangement in FIG. 9 by virtue of further contact-making elements 82 in order to make contact with the additional second card contacts. A second contact-making element 82 for making contact with the second card contacts is provided on each side of one of the contact-making elements 81 that make contact with the first card contacts.

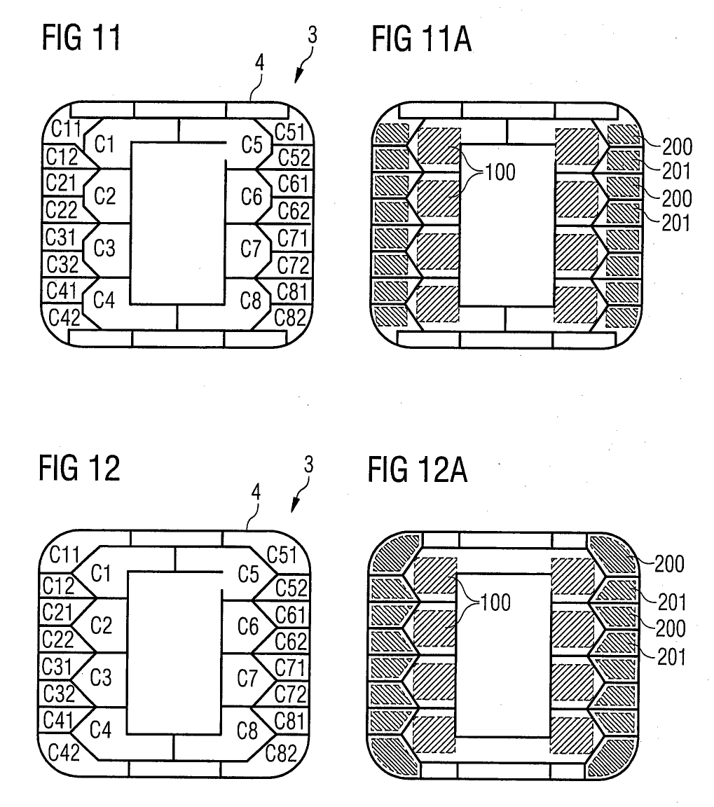

FIG. 11 shows the card contact array 3 of a sixth exemplary embodiment with first card contacts C1, C2, C3, C4, C5, C6, C7, C8 and second card contacts C11, C12, C21, C22, C31, C32, C41, C42, C51, C52, C61, C62, C71, C72, C81, C82. In this exemplary embodiment, the separating line runs in zigzag fashion between the first card contacts C1, C2, C3, C4, C5, C6, C7, C8 and the second card contacts C11, C12, C21, C22, C31, C32, C41, C42, C51, C52, C61, C62, C71, C72, C81, C82.

FIG. 12 shows a seventh exemplary embodiment, which differs from the sixth exemplary embodiment only by virtue of the form of the zigzag separating line between the first and second card contacts and the accompanying slightly varied form of the card contacts.

FIG. 11A shows the contact regions 100, 200, 201 assigned to the first and second card contacts in FIG. 11. The arrangement of the contact regions matches the arrangement illustrated in FIG. 7A although mutually assigned first and second card contacts differ with regard to the card contact geometry. Consequently, the corresponding cards can be operated in the same contact-making device.

The contact regions 100 illustrated in FIG. 11A are in part positioned in such a way that separating lines between the card contacts intersect the edge region of the contact regions. This primarily relates to corner regions of the first contact regions 100 which intersect the obliquely running separating lines. However, since the contact-making elements are adjusted centrally in the contact region 100 and 200, 201, the risk of faulty contact being made with a card contact not assigned to the contact region is negligible.

The contact regions illustrated in FIG. 12A are assigned to the card contact arrangement in accordance with FIG. 12. The first contact regions 100 are rectangular in ISO-conforming fashion, although the first card contacts C1, C2, C3, C4, C5, C6, C7, C8 have more than four corners. The second contact regions 200 and 201 are adapted with regard to their form to the tapering second card contacts C1, C12, C21, C22, C31, C32, C41, C42, C51, C52, C61, C62, C71, C72, C81, C82, as illustrated in FIG. 9.

It should be noted that contact can be made with the contact regions 100, 200, 201 of the card contacts that are illustrated in FIGS. 11A and 12A by means of a contact-making device having contact-making elements arranged in accordance with FIG. 10.

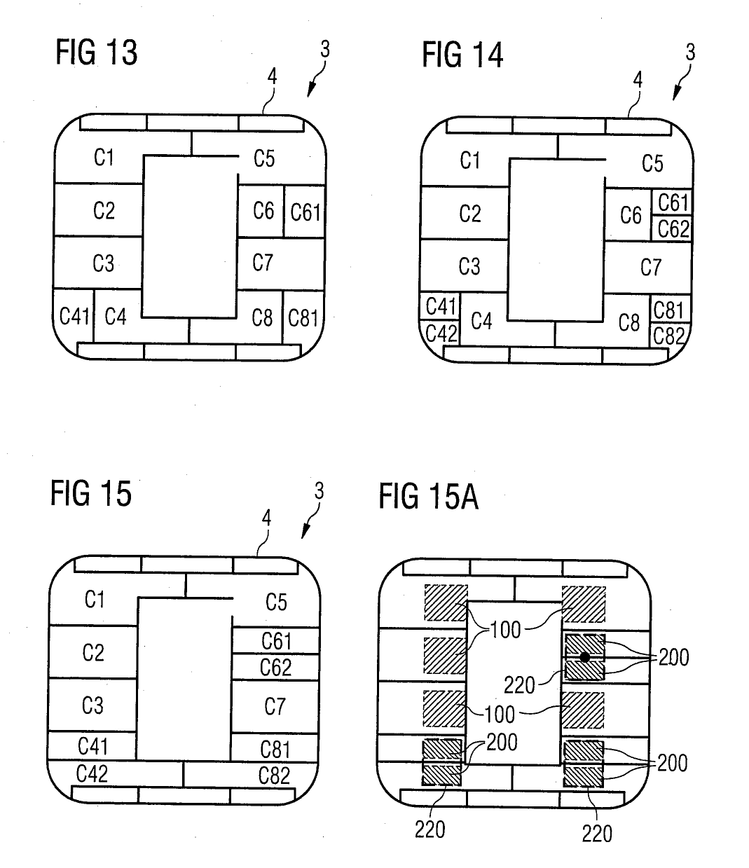

FIG. 13 shows the card contact array 3 which differs from the conventional card contact array, as illustrated in FIG. 2, by virtue of the fact that only the conventional card contacts C4, C6 and C8 are divided into first and second card contacts C4, C41; C6, C61; C8, C81. These card contacts are not preallocated by the ISO standard, but rather can be allocated in a user-specific manner. The card contacts C4, C6, C8 are divided by a vertical separating line, so that the adjacent second card contacts C41, C61 and C81 are respectively arranged alongside the first card contacts C4, C6, C8.

FIG. 14 differs from FIG. 13 by virtue of the fact that the second card contacts C41, C61, C81 have again been divided by cutouts along a horizontal separating line in order to provide further second card contacts C42, C62, C82.

FIG. 15 shows an exemplary embodiment in which the card contacts designated as C4, C6 and C8 in the conventional smart card, as illustrated in FIG. 2, are divided horizontally into in each case two second card contacts C41, C42, C61, C62, C81, C82. This division does not conform to the contact regions assigned to the card contacts C4, C6, C8 in the ISO standard. The contact regions comprise in each case regions of two second card contacts C41, C42; C61, C62; C81, C82. However, since the ISO card contacts C4, C6 and C8 can be allocated freely, the smart card having the card contact array 3 illustrated in FIG. 15 enables operation provided in the ISO protocol via the card contacts C1, C2, C3, C5, C7 since the corresponding contact regions are ISO conforming.

FIG. 15A shows the arrangement of the contact regions 100, 200 for the card contact array 3 illustrated in FIG. 15. The regions which conform to the arrangement of the card contacts that is specified in the ISO standard comprise the contact regions 100 of the first card contacts C1, C2, C3, C5 and C7 and also regions that are bordered with a thick dashed line and are identified by the reference symbol 220. Two second card contacts C41, C42; C61, C62; C81, C82 in each case comprise part of one of the regions 220. In contrast to the ISO card, in which only one card contact comprises one of the regions 220, so that an edge line of the corresponding card contact that runs along the edges of the card contact completely encloses the region, in this exemplary embodiment two card contacts C41, C42; C61, C62; C81, C82 are positioned such that their edge lines enclose only part of the region 220.

When contact is made with the card contact array 3 illustrated in FIG. 15 by means of a contact-making device for ISO cards, the contact-making elements for the card contacts designated as C4, C6 and C8 in the ISO standard are positioned on the separating lines between the second card contacts C41 and C42 and also the second card contacts C61 and C62 and also the second card contacts C81 and C82, as indicated by way of example by the point 22. The respectively adjacent second card contacts C41, C42 and C61, C62 and C81, C82 are short-circuited on account of the finite extent of the contact region of the contact-making element. Operation of the smart card is nevertheless possible in accordance with the protocol provided in the ISO standard since these card contacts C41, C42, C61, C62, C81, C82 are not required therefor.

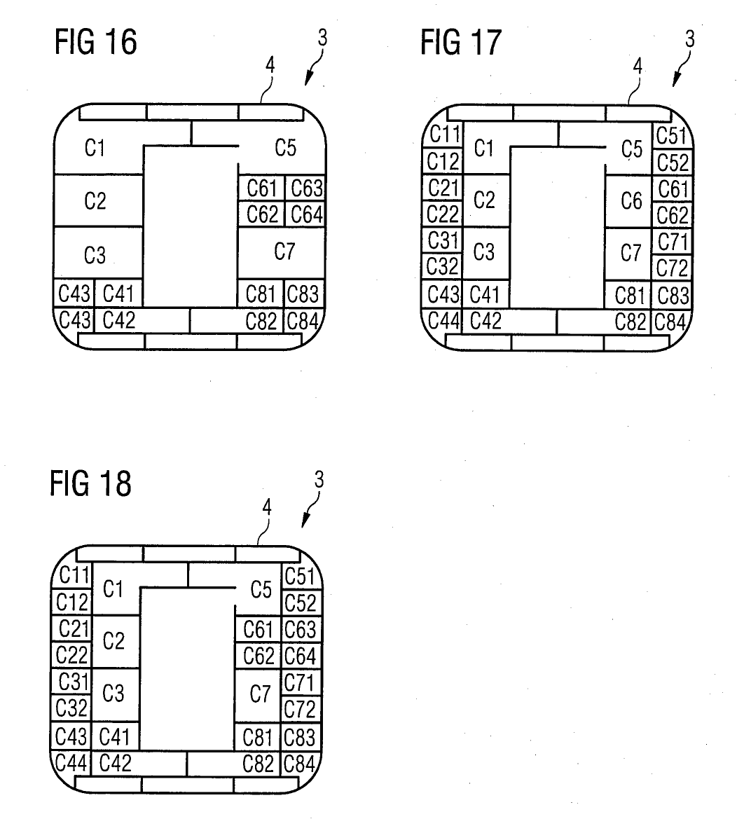

FIG. 16 differs from FIG. 15 merely by virtue of the fact that the conventional card contacts C4, C6 and C8 are now divided in each case by a vertical and horizontal separating line into four second card contacts C41, C42, C43, C44; C61, C62, C63, C64; C81, C82, C83, C84. The explanations given above are applicable with regard to the operation of such a card in accordance with the ISO standard.

FIG. 17 shows an exemplary embodiment in which the conventional card contacts C1, C2, C3, C5, C6, C7 are divided into first card contacts C1, C2, C3, C5, C6, C7 and second card contacts C11, C12, C21, C22, C31, C32, C51, C52, C61, C62, C71, C72 in such a way that the contact regions assigned to the first card contacts C1, C2, C3, C5, C6, C7 are ISO conforming. The card contacts C4, C8 have been divided, as in the previous exemplary embodiment, into in each case four second card contacts C41, C42, C43, C44, C81, C82, C83, C84 which are not ISO conforming.

FIG. 18 differs from the previous exemplary embodiment merely by virtue of the fact that the previous first card contact C6 has now been divided into two second card contacts C61, C62.

It is expressly pointed out that the features of the card contact arrangements and contact region arrangements shown in the exemplary embodiments can be combined with one another.

Owing to the backward compatibility required, which comprises the fact that the smart card having first and second card contacts can also be connected in a conventional contact-making device, or that a contact-making device for such a smart card can also operate an ISO card, firstly a handshake protocol is carried out when the smart card is connected.

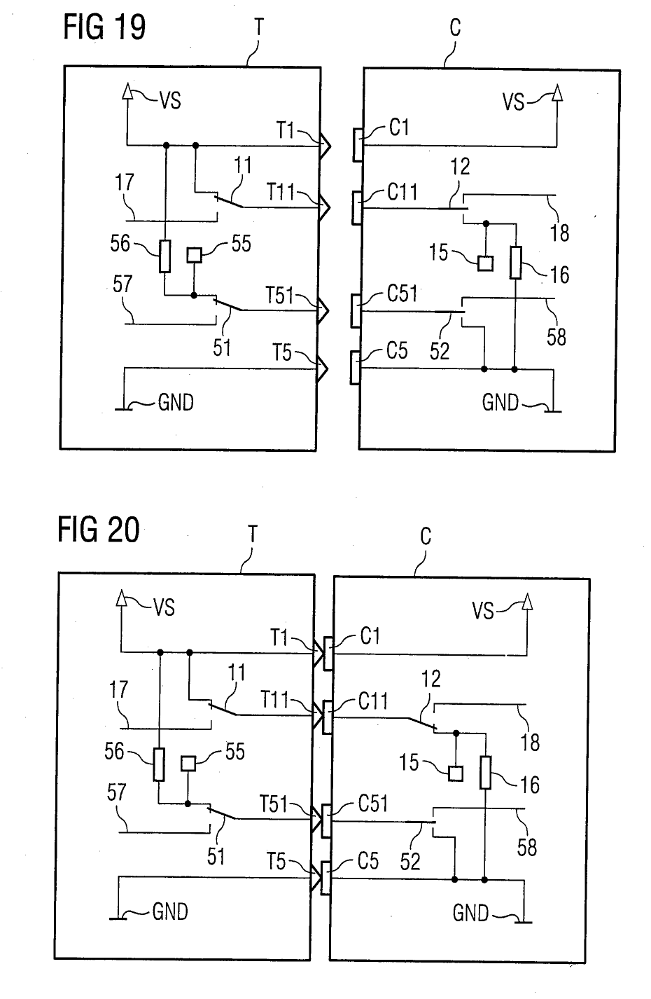

FIGS. 19 to 23 illustrate the handshake protocol.

FIG. 19 shows a block diagram with part of the smart card C and part of the contact-making device T. For illustrating the method, the representation is restricted to four contacts between four card contacts C1, C11, C51, C5 and four contact-making elements T1, T11, T51, T5.

The smart card C comprises the first card contacts C1, C5 and also the second card contacts C11, C51. It should be noted that the geometrically correct arrangement of the card contacts has been dispensed with for illustrating the handshake protocol.

The smart card C comprises a first switch 12 and a second switch 52. The first switch makes it possible either to couple the second card contact C11 to a first line 18 or to couple it via a first resistor 16 to the first card contact C5 or to decouple the second card contact C11. The second switch 52 makes it possible either to couple the second card contact C51 to a second line 58 or to couple it to the first card contact C5 or to decouple the second card contact C51.

When the smart card C is not connected, the second card contacts C11, C51 are decoupled.

A first detection unit 15 for potential detection having an input is coupled between the first resistor 16 and the first switch 12 on the input side.

The contact-making device T comprises the first contact-making elements T1, T5 and the second contact-making elements T11, T51.

The contact-making device T comprises a third switch 11 and a fourth switch 51. The third switch 11 makes it possible either to couple the second contact-making element T11 to a third line 17 or to couple it to the contact-making element T1 or to decouple the second contact-making element T11. The fourth switch 51 makes it possible either to couple the second contact-making element T51 to a fourth line 57 or to couple it via a second resistor 56 to the first contact-making element T1 or to decouple it.

A second detection unit 55 for potential detection is coupled between the second resistor 56 and the fourth switch 51 on the input side.

The first and second contact-making elements T1, T5, T11, T51 are arranged in such a way that they touch the first and second card contacts C1, C5, C11, C51 when the smart card C is connected, so that the contact-making C1-T1; T11-C11; T51-C51; T5-C5 is effected.

If no smart card C is connected, the second contact-making elements T11, T51 are coupled to the first contact-making element T1 via the third and fourth switch 11, 51, respectively.

A supply potential VS is provided at the first contact-making element T1, and a reference potential GND is provided at the first contact-making element T5.

If no smart card is connected, both the third switch 11 and the fourth switch 51 are coupled to the supply potential VS applied to the first contact-making element T1. The supply potential VS is present at the second detection unit 55 on the input side.

It is conceivable for the second detection unit 55 to be in a quiescent mode if no smart card C is connected.

FIG. 20 shows that when the smart card C is connected, the contact-making elements T1, T11, T51, T5 touch the card contacts C1, C11, C51, C5. Consequently, the supply potential VS is present at the first card contact C1 and likewise at the assigned second card contact C11, and the card contact C5 and likewise the assigned second card contact C51 are at the reference potential GND.

As soon as the supply voltage is present between the card contacts C1 and C5, the second card contact C11 is coupled to the first card contact C5 via the first switch 12 and the first resistor 16. The supply potential VS is present at the first detection unit 15 since it is coupled to the contact-making element T11 via the first switch 12 and the card contact C11.

Upon connecting the smart card C to a conventional contact-making device T, contact would not have been made with the card contact C11 by a contact-making element, see FIG. 26. Consequently, the supply potential VS is not present at the card contact C11 and the first detection unit 15 is at the reference potential GND. The type of contact-making device can thus be deduced from the potential detected at the first detection unit 15.

The second card contacts C11, C51 can be deactivated in the case of a conventional contact-making device T having been detected. Communication with the contact-making device T is then effected only via the first card contacts C1, C5 or further first card contacts in accordance with the ISO protocol.

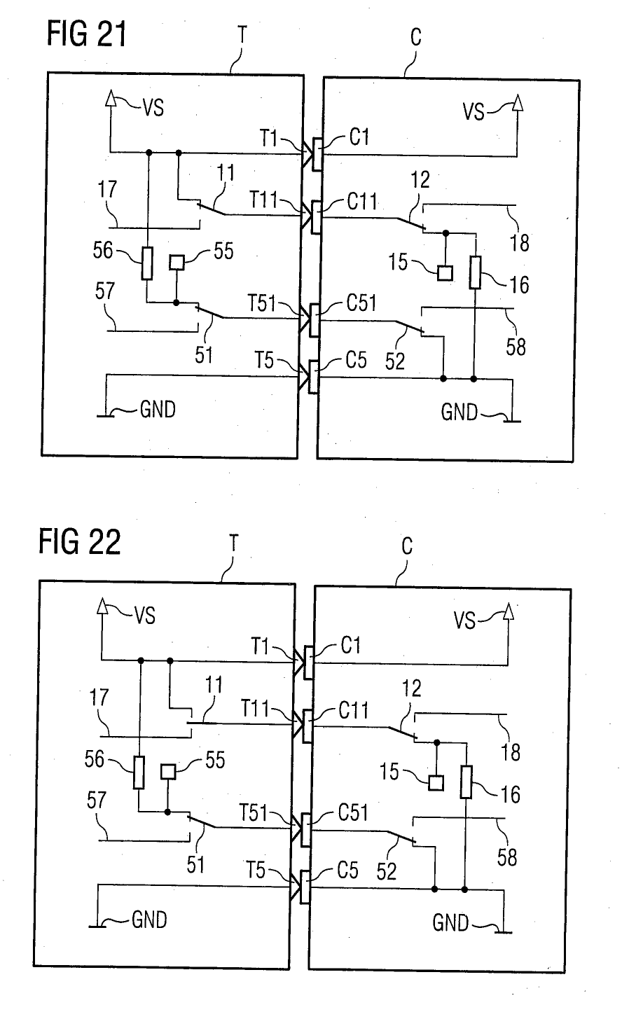

FIG. 21 shows the next step of the handshake protocol. If the supply potential VS has been detected at the first detection unit 15, the second switch 52 is coupled to the reference potential GND present at the first card contact C5. As a result, both the second card contact C51 and the contact-making element T51 coupled thereto are at the reference potential GND. Since the contact-making element T51 is coupled to the second detection unit 55 via the fourth switch 51, the reference potential GND is also present at the detection unit on the input side.

If the second detection unit 55 is in a quiescent mode, the application of the reference potential GND is simultaneously interpreted as an activation signal for activating the second detection unit 55.

It should be noted that when an ISO card is connected, a single card contact comprises the region of the card contacts C5 and C51 which is at the reference potential GND. In this case, too, the reference potential GND is detected at the second detection unit 55 and, if appropriate, interpreted as a wake-up signal.

FIG. 22 shows the next step of the handshake protocol, in order to distinguish on the part of the contact-making device T whether a smart card C having first and second card contacts or an ISO card is connected.

The third switch 11 decouples the contact-making element T11 both from the supply potential VS and from the third line 17. Consequently, the supply potential VS is now no longer present at the second card contact C11 of the smart card C. The first detection unit 15 detects the reference potential GND. This confirms to the smart card C that a new contact-making device T is connected.

In the contact-making device T, with the decoupling of the contact-making element T11 a time counter is started. Until the progression of the time counter finishes, the contact-making device T waits for a reaction of the smart card C according to the protocol.

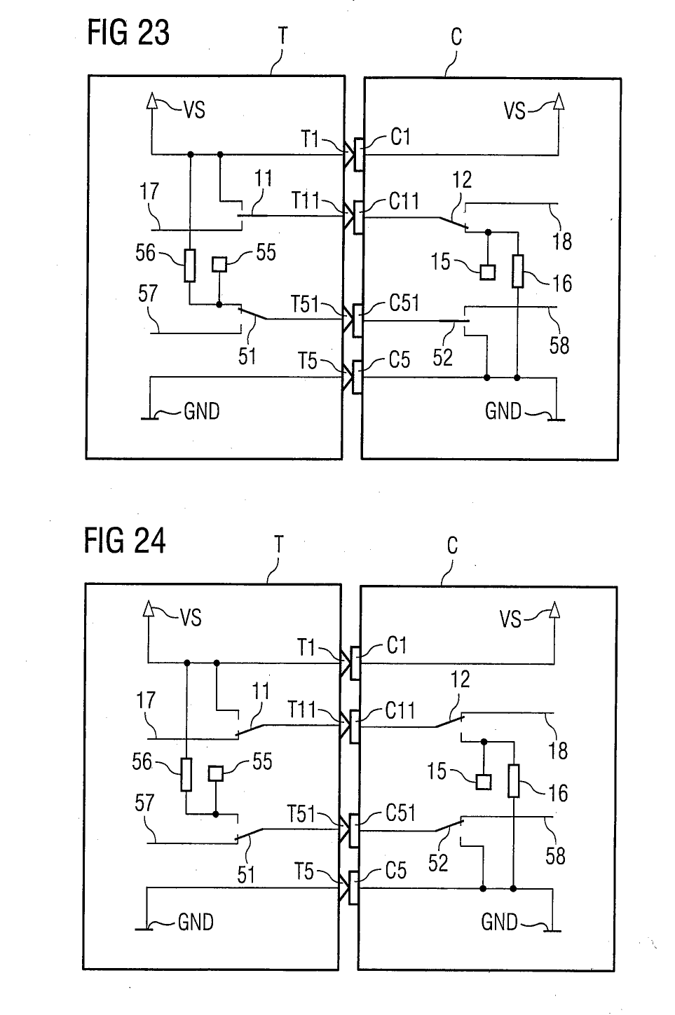

FIG. 23 shows the reaction of the smart card C according to the protocol. The second card contact C51 is decoupled from the reference potential GND by the second switch 52. Consequently, the reference potential GND is no longer present at the contact-making element T51 connected thereto. The supply potential VS is detected at the second detection unit 55. This serves as confirmation to the contact-making device T that a smart card C having first and second card contacts is connected.

Should an ISO card be connected to the contact-making device described above, the card contact connected to the contact-making element T51 could not be decoupled since it is the same card contact with which contact would have been made by the contact-making element T5. In this case, the time counter proceeds without a reaction by the smart card. A possible consequence would be that the contact-making device T communicates with the smart card C only in accordance with the ISO protocol via its five or eight card contacts provided therefor.

In order to enable communication with the smart card C via the second card contacts C11, C51 in a normal operating mode, the third switch 11 and the fourth switch 51 are coupled to the lines 17 and 57, respectively. The first and second switches 12, 52 are coupled to the first and second lines 18, 58, respectively. The first and third lines 18, 17 and also the second and fourth lines 58, 57 are thus coupled.

FIG. 24 shows the corresponding switch positions in the normal operating mode.

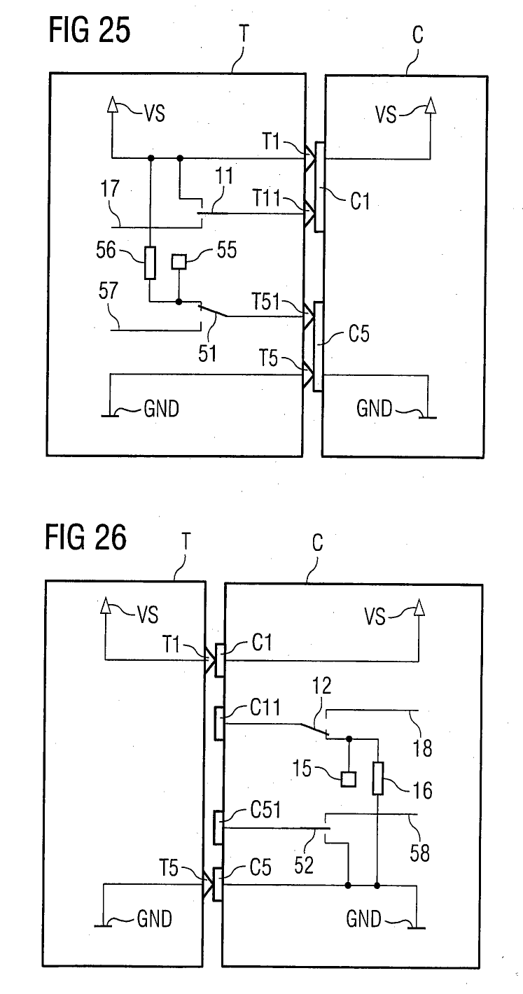

FIG. 25 shows a contact-making device T according to the invention, to which an ISO card C is connected. On account of the larger area of the card contacts C1 and C5, contact is made with the latter in each case by two contact-making elements T1, T11 and T51, T5, respectively. Consequently, the same potential is in each case present at the contact-making elements T1, T11 and T51, T5, respectively. They are short-circuited by the corresponding card contacts C1 and C5, respectively.

FIG. 26 shows a conventional contact-making device T for ISO cards, to which a smart card C according to the invention having the first card contacts C1, C5 and the second card contacts C11, C51 is connected. Contact is made only with the first contacts C1 and C5 by the contact-making elements T1 and T5. No potential is present at the second card contacts C11 and C51.

The essential idea of the handshake protocol is that each of the individual steps which are executed either by the contact-making device T or the smart card C is concomitantly confirmed by signaling from the other end. Two first card contacts and their assigned second card contacts are sufficient for the handshake protocol. The selection of the card contacts comes under a definition.

On account of the backward compatibility, it is not desirable for the type of contact-making device to be detected independently, for example by means of steps going beyond the ISO communication protocol, in smart cards having first and second card contacts. This is because such a smart card would no longer be backward compatible with the ISO protocol. Consequently, the detection must also be effected in a manner accordant with the ISO protocol, as is done by means of the handshake protocol described above.

What is claimed is:

1. A smart card module, comprising:
first card contacts positioned within a boundary line, each first card contact including one of a plurality of contact regions, each contact region conforming in size to ISO standard 7816 and conforming with regard to distance from and arrangement with respect to one of the other contact regions to the ISO standard 7816; and
second card contacts positioned within the boundary line, one of the second card contacts being arranged between at least one of the first card contacts and the boundary line or including a part of one of the contact regions,
wherein the first and second card contacts include a contact surface and at least one chip having an integrated circuit is arranged on an opposite side to the contact surface, and the chip includes chip contacts which are electrically connected to at least one of the first and second card contacts.

2. The smart card module as claimed in claim 1, wherein the conformity of the first card contacts relates to card contacts designated as C1, C2, C3, C5 and C7 in the ISO standard 7816.

3. The smart card module as claimed in claim 1, wherein an upper edge of at least one first card contact and an upper edge of at least one second card contact are oriented along a first line.

4. The smart card module as claimed in claim 1, wherein a lower edge of at least one first card contact and a lower edge of at least one second card contact are oriented along a second line.

5. The smart card module as claimed in claim 1, wherein at least two second card contacts are positioned in a region between a first line, along which an upper edge of one of the first card contacts is oriented, and a second line, along which a lower edge of said first card contact is oriented.

6. The smart card module as claimed in claim 5, wherein mutually adjacent edges of the second card contacts run parallel or perpendicular to the first and/or the second line.

7. The smart card module as claimed in claim 1, wherein the first card contacts are arranged in two columns in each case parallel to one direction and adjacent edges of at least one of the first card contacts and at least one of the second card contacts run at an angle with respect to the one direction.

8. The smart card module as claimed in claim 1, wherein an upper edge and a lower edge of one of the second card contacts is oriented along a respective line such that upper and lower edges of the first card contacts are not oriented along one of the respective lines.

9. The smart card module as claimed in claim 1, wherein the at least one chip detects whether contact is made only with the first card contacts or contact is made with the first and at least some of the second card contacts.

10. The smart card module as claimed in claim 1, wherein the at least one chip has a first means which detects whether a potential is present on an input side, wherein the first means can be coupled to one of the second card contacts on the input side.

11. The smart card module as claimed in claim 10, wherein the first means detects whether a first or second potential is present on the input side.

12. The smart card module as claimed in claim 11, wherein the second card contact to which the first means can be coupled is assigned to a first card contact to which a first potential can be applied.

13. The smart card module as claimed in claim 11, wherein the first means is coupled to one of the first card contacts, to which a second potential can be applied, on the input side.

14. The smart card module as claimed in claim 13, wherein the first means is coupled to the one of the first card contacts via a first resistor.

15. The smart card module as claimed in claim 13, wherein another second card contact, which is assigned to the one of the first card contacts, can be coupled thereto.

16. The smart card module as claimed in claim 1, wherein the second card contacts can be deactivated.

17. A smart card module comprising:
first card contacts positioned within a boundary line, each first card contact including one of a plurality of contact regions, wherein a size of each contact region conforms to ISO standard 7816 and a distance from and arrangement with respect to one of the other contact regions to the card contact conforms to the ISO standard 7816; and
second card contacts positioned within the boundary line, at least two of the second card contacts being arranged between at least one of the first card contacts and the boundary line in a region delimited by a first and a second line, the first line being oriented at an upper edge of the first card contact and the second line being oriented at a lower edge of the first card contact,
wherein the first and second card contacts include a contact surface and at least one chip being arranged on an opposite side to the contact surface, the chip includes an integrated circuit and chip contacts which are electrically connected to the integrated circuit, and at least one of the chip contacts is electrically connected to the card contacts.

18. The smart card module as claimed in claim 17, wherein the conformity of the first card contacts relates to card contacts designated as C1, C2, C3, C5 and C7 in the ISO standard 7816.

19. The smart card module as claimed in claim 17, wherein mutually adjacent edges of the second card contacts run parallel or perpendicular to one of the first line and the second line.

20. The smart card module as claimed in claim 17, wherein the first card contacts are arranged in two columns in each case parallel to one direction and adjacent edges of at least one of the first card contacts and at least one of the second card contacts run at an angle with respect to the one direction.

21. A smart card comprising the smart card module as claimed in claim 17.

22. The smart card as claimed in claim 21, wherein a size of the smart card conforms to the ISO standard 7816 and the distances between the regions and the smart card edge conform to the distances between the card contacts and the card edge that are standardized in the ISO standard 7816.

23. The smart card as claimed in claim 21, wherein the positioning of at least some of the first and second card contacts conforms to a standard other than the ISO standard 7816.

24. A smart card contact-making device for making contact with a smart card as claimed in claim 21, comprising first and second contact-making elements making contact with the first and the second card contacts, respectively, of the smart card.

25. The smart card contact-making device as claimed in claim 24, wherein the smart card contact-making device detects whether a connected smart card comprises only ISO-conforming card contacts, or whether the connected smart card comprises the first and the second card contacts.

26. The smart card contact-making device as claimed in claim 24, further comprising a detector having an input in order to detect whether a potential is present on an input side, wherein the detector can be coupled to one of the second contact-making elements on the input side.

27. The smart card contact-making device as claimed in claim 26, wherein the detector detects whether a first or second potential is present on the input side.

28. The smart card contact-making device as claimed in claim 27, wherein one of the first contact-making elements provides the second potential, and the first and one of the second contact-making elements make contact with one of the first card contacts and a second card contact assigned to the first card contact of the smart card.

29. The smart card contact-making device as claimed in claim 27, wherein the detector is coupled to another first contact-making element, which provides the first potential.

30. The smart card contact-making device as claimed in claim 29, wherein the detector is coupled to the other first contact-making element via a second resistor.

31. The smart card contact-making device as claimed in claim 29, wherein another second contact-making element can be coupled to the other first contact-making element, wherein the other first and the other second contact-making element make contact with one of the first card contacts and a second card contact assigned thereto of the smart card.

32. The smart card contact-making device as claimed in claim 24, further comprising a detecting means for detecting whether a potential is present on an input side, wherein the detecting means can be coupled to one of the second contact-making elements on the input side.

33. A method for operating a smart card, comprising:
applying a first potential to a first region of a card contact array or applying the first potential to the first region of the card contact array and to a second region of the card contact array which is assigned to the first region; and
testing of whether the first potential is present at the second region of the card contact array.

34. The method as claimed in claim 33, further comprising applying a second potential to a third region of the card contact array.

35. The method as claimed in claim 33, further comprising deactivating at least one card contact which comprises the second region if the first potential is not present at the second region.

36. The method as claimed in claim 35, further comprising internally coupling a card contact comprising a fourth region, which is assigned to the third region, to the second potential as soon as the first potential is present at the second region.

37. The method as claimed in claim 36, further comprising decoupling the first potential from the second region.

38. The method as claimed in claim 37, further comprising decoupling the fourth region from the second potential.

39. The method as claimed in claim 37, further comprising testing whether the second potential is present at the fourth region.

40. The method as claimed in claim 39, wherein the testing is effected after a predetermined time interval has elapsed.

41. A smart card module having an edge, a first side and a second side, the smart card module comprising:
a plurality of first contact means, at least one of said first contact means having a size and arrangement conforming to ISO standard 7816; and
a plurality of second contact means, at least one of said second contact means arranged between at least one of the first contact means and the edge, wherein the first and second contacts means are on the first side of the smart card module; and
at least one integrated circuit arranged on the second side of the smart card module, the integrated circuit being electrically connected to at least one of the contact means.

42. An apparatus for operating a smart card, comprising:
means for applying a first potential to a first region of a card contact array or applying the first potential to the first region of the card contact array and to a second region of the card contact array which is assigned to the first region; and
means for testing of whether the first potential is present at the second region of the card contact array.
